(19) United States
(12) Patent Application Publication
(10) Pub. No.: US 2005/0071019 A1
(43) Pub. Date: Mar. 31, 2005

(54) Processor utilization modeling for data networking software

(76) Inventor: Erin Wanju Liao, Parsippany, NJ (US)

Correspondence Address: GREENBERG TRAURIG, LLP, 885 Third Avenue, New York, NY, 10022, US

(21) Appl. No.: 10/660,962

(22) Filed: Sep. 12, 2003

(51) Int. Cl. G05B 13/02

(52) U.S. Cl. 700/28

(57) ABSTRACT

Nodes of a communication network are evaluated by calculating the processor occupancy of a processor processing subscriber information at that node. The calculated processor occupancy represents the capacity of the node. The processor occupancy and thus the node capacity is calculated from a traffic model constructed from a linear combination of mathematical equations describing the relationship between a measured processor occupancy value for a particular type of information and a particular data rate.

### FIELD OF THE INVENTION

The invention relates generally to communication networks.

### BACKGROUND OF THE INVENTION

Communication networks are typically constructed as interconnecting nodes whereby the nodes have equipment that process information flowing through the network. The service providers that own, operate and otherwise maintain communication networks want to ensure that such networks have sufficient capacity to handle the demands of their subscribers. In particular, the service providers desire that the various nodes of the network have sufficient capacity such that the nodes can process subscriber information (i.e., traffic information generated by subscribers) properly without any significant degradation in the performance of the communication network. A communication node typically has a processor that processes received subscriber information and then transmit such processed information to another node in the network or to subscriber equipment (e.g., computer, cellular phone, pager). The capacity of a node relates to the amount of subscriber information that can be properly processed by the node for a defined period of time. The defined period of time is usually related to the rate at which the subscriber information is being received by the node and/or the rate at which information is being transmitted by the node. For example if the rate at which user information is being received is Z bit per second, the defined period of time can be 1/Z seconds.

Service providers typically want to calculate the user traffic handling capacity of the network and also monitor the network during its operation to detect when the network is operating near its calculated capacity. In this manner, a service provider is able to take preventive measures to prevent the communication network from being overloaded. Service providers typically calculate the capacity of the nodes of the network to make sure that no node is operating at or dangerously near its calculated capacity. Typically a capacity threshold is arbitrarily set by the service provider such that preventive measures are taken when and if the threshold is reached by a node. By calculating and monitoring the current capacity status of the nodes of the network, a service provider is able to keep the nodes operating without any major problems. For example, a node with a certain known capacity may be detected to have reached 70% of its capacity where 70% is the threshold set by the service provider. Once the threshold for that node is reached, the service provider may be able to provide more bandwidth to that node or provide additional resources to that node (e.g., add more processors or more processing capability) to increase the capacity of the node. Otherwise, if the node is allowed to reach its capacity, congestion may occur at that node where the node is unable to process incoming user information fast enough resulting in some of the incoming information being lost. From a subscriber's standpoint, a congested node may be manifested as a dropped call, or a subscriber's inability to gain access to the Internet for example.

The processing of the user traffic information at a node is typically handled by one or more processors at that node. The user traffic information handling capacity of the node of a network is usually measured by measuring the processor occupancy of the processors. The processor occupancy (PO) is usually expressed in terms of a percentage that describes how much work is being performed by the processor relative to the total amount of work that such processor is designed to perform at a particular instant of time. The amount of work that is performed by a processor is usually expressed in terms of the number of instructions per unit time (e.g., seconds) that the processor is executing. For example, if a processor is designed to execute 10 million instructions per second and is currently executing 6.5 million instructions per second, the PO of that processor is thus 65%. Service providers usually assume a one to one relationship between the PO of the traffic handling processor at a node of a communication network and the current capacity of that node. For the example just mentioned above, the current capacity of the node at which the processor is located would also be 65%.

In many of the voice networks that provided telephone service to the public such as the Public Switched Telephone Network (PSTN), the amount of resources (e.g., bandwidth) provided to a subscriber of the phone network was usually known. The PSTN and other similar networks are known as circuit-switched networks whereby a known bandwidth amount is allocated to a user gaining access to the network. For example, for a voice call a circuit is created from the calling party to the called party and that circuit is provided to those parties for the duration of the call. Because the resources associated with a circuit are known, the PO associated for each such circuit is also known. Thus, the PO of a processor at a node is determined simply by determining the number of subscribers being serviced by the processor. For example, suppose there is one processor at a particular node and each circuit used being serviced results in a 10% PO. The PO for that node when three subscribers are being serviced is thus 30%. There is thus a straight forward linear relationship between the number of subscribers being serviced by a node and the PO of that node. However, with the advent of data networks, which convey (i.e., transmit and/or receive) information in terms of packets or blocks of bits, the determination of the capacity of a node in such a network is relatively much more complicated.

Unlike circuit switched networks where the amount of resources allocated to a subscriber is a fixed quantity, in data networks such as packet switching networks the amount of resources allocated to a subscriber varies in time and, more importantly, varies as a function of the type of information being conveyed by the subscriber. For example, one subscriber may be using the same amount or more bandwidth than 10 subscribers because that subscriber is transmitting graphics and video data which use relatively great amount of bandwidth and the 10 users each is transmitting e-mails which use much less bandwidth. Further, because of the bursty nature of packet data, a great amount of information may be conveyed through a node at one instant and then relatively little or no information is conveyed in the same node at another instant. Therefore, at any particular instant of time, the PO of the processor can vary greatly. As a result, the PO of a node handling packets of data cannot be determined by simply knowing the number of subscribers being serviced by that node; this is because the amount of information associated with a subscriber is not fixed and can vary greatly and the number of subscriber information passing through the node varies from instant to instant.

The type of data and the characteristics of different types of data can be simulated to determine the PO associated with such data at a great cost in equipment and associated software. It is relatively difficult to use laboratory equipment to simulate certain traffic patterns associated with certain types of datacommonly known as Application Types (AT). An AT is a certain type of information usually distinguished from other types of information by the size of the packets (i.e., grouping of bits) used to convey (i.e., transmit and/or receive) the information. Examples of AT's comprise e-mail, graphics, video, audio and text files. Different Application Types follow different protocols and the information associated with the different AT's are formatted differently. For example, data files are conveyed using the FTP (File Transfer Protocol) which defines the number of bits in each block of data transmitted. In general, a protocol is a set of rules that dictate how communication is to be initiated, maintained and terminated. Protocols are usually part of a standard that are usually established by governmental bodies and/or industry groups. The standard is an accepted method for communicating and contains various protocols.

Service providers of data communication networks want to determine the capacity of the nodes of such networks for the reasons discussed above. However, because of the inconsistent nature of different types of information, i.e., different AT's (e.g., graphics, video, audio, text) present in a data communication network an accurate and relatively inexpensive and easy to implement technique for determining the capacity of a node is therefore needed by these service providers.

### SUMMARY OF THE INVENTION

The present invention provides a method for evaluating a node of a communication network. First, the method defines different types of information that are conveyed through the node. A set of relationships between the capacity of the node and the different types of subscriber information flowing through the node is developed for different information rates. A traffic model for the node is provided where such model is constructed from a combination of one or more of the developed relationships. The capacity of the node is calculated from the provided traffic model.

In one embodiment, the occupancy of one or more processors used to process the subscriber information at the node is calculated from a provided traffic model. The traffic model comprises a linear combination of various equations each of which describes a relationship between processor occupancy and a particular type of subscriber information at a particular data rate. A set of equations for different types of information—called application types—is generated to calculate different processor occupancies for different data rates. The total processor occupancy from the various application types at certain information rates is thus calculated from the traffic model. The calculated processor occupancy is therefore the capacity of the node for the provided model.

### BRIEF DESCRIPTION OF THE DRAWINGS

FIG. 1 depicts a flowchart of the method of the present invention;

FIG. 2 depicts a graph of various curves showing the relationship between processor occupancy and various information rates.

### DETAILED DESCRIPTION

The present invention provides a method for evaluating a node of a communication network. First, the method defines different types of information that are conveyed through the node. A set of relationships between the capacity of the node and the different types of subscriber information flowing through the node is developed for different information rates. A traffic model for the node is provided where such model is constructed from a combination of one or more of the developed relationships. The capacity of the node is calculated from the provided traffic model.

In one embodiment, the occupancy of one or more processors used to process the subscriber information at the node is calculated from a provided traffic model. The traffic model comprises a linear combination of various equations each of which describes a relationship between processor occupancy and a particular type of subscriber information at a particular data rate. A set of equations for different types of information—called application types—is generated to calculate different processor occupancies for different data rates. The total processor occupancy from the various application types at certain information rates is thus calculated from the traffic model. The calculated processor occupancy is therefore the capacity of the node for the provided model.

The method of the present invention will be described in the context of a node of a wireless communication network through which information in the form of packets or groups of bits are conveyed. The information can represent voice, video, graphics, text and any combination thereof. For ease of explanation, it will be assumed that there is one processor at the node which is used to process subscriber information. The total PO of the subscriber information processor will be calculated and will thus represent the capacity of the node; that is the PO for the downlink and the uplink of the node will be calculated resulting in the total PO and thus the total capacity of the node. The node can be a base station of the wireless communication network, a Message Switching Center (MSC) or any other communication hub of the network. The base station contains processing equipment for receiving information from subscriber equipment (e.g., cellular phone, computer, pager) over a communication channel commonly referred to as the uplink. Further the equipment at the base station also processes information being transmitted to subscriber equipment over a communication channel commonly referred to as the downlink. The MSC performs switching operation for conveying subscriber information between the wireless communication network and one or more other communication networks. The MSC also has an uplink channel and a downlink channel. It will be readily understood however that the method of the present invention is applicable to various types of communication networks (e.g., computer communication network, private Internet, public Internet) other than wireless communication networks and is certainly not limited to wireless communication networks.

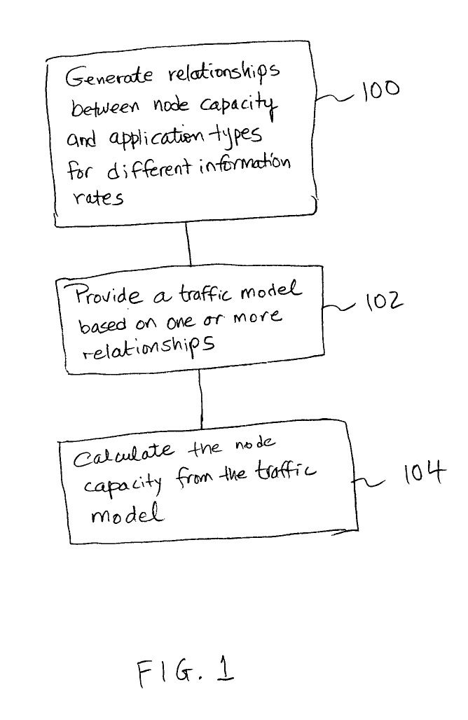

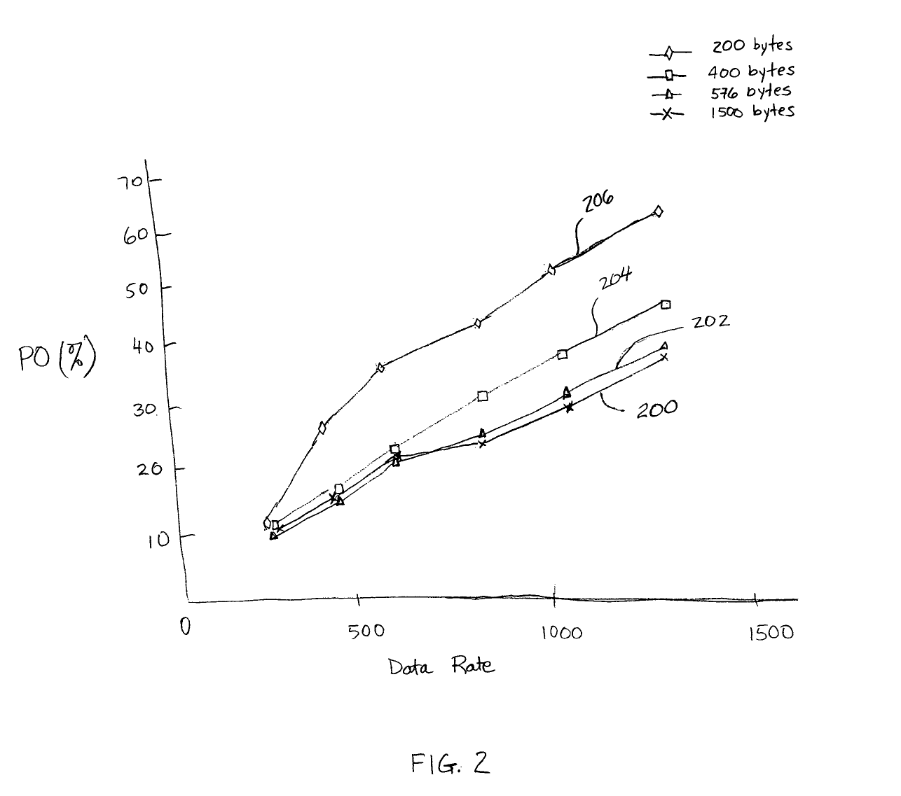

Referring now to FIG. 1, in step 100 relationships are generated from measured node capacities of different application types at different information rates. In the embodiment being discussed, a mathematical relationship between the processor occupancy for a particular application type and data rate is generated. Because there are different data rates, several equations for the same application type are generated. For example, suppose the application type is a file type; that is the data being received and/or transmitted at the base station represent textual information that is part of a computer file. The network may be designed to convey files at N different data rates where N is an integer equal to 1 or greater. Thus, N different mathematical equations will be generated for the uplink (UL) of the node and assuming the downlink (DL) also has N different data rates, N equations for the downlink will also be generated for the node. The relationship between processor occupancy and data rate can be expressed in the following format:
PO=F₁* UL Data Rate+C₁ (1)
PO=f₁* DL Data Rate+c₁ (2)
where both equations (1) and (2) are obtained by measuring the processor occupancy for different data rates and each measured PO value is used to construct a linear graph having a slope of F₁ or f₁. An example of such a graph is shown in FIG. 2 for different application types. One way of distinguishing the different application types is the number of bytes their packets contain. Referring to FIG. 2, the graph shown therein depicts PO-data rate curves for different application types and the different packet sizes for different application types are also shown. Examples of application types comprise files, video clips, graphics data, voice, e-mail and any combination of these types. Note that equations (1) and (2) are linear equations with the data rate representing the varying parameter or variable and where F₁ and f₁ represent the slope of the curves. C₁ and c₁ are constants that represent “idle PO”, i.e., the processor occupancy due to system and maintenance overhead when there is no traffic information. The node's idle PO should be the same regardless of packet size, i.e., regardless of the application type. The various equations for the different data rates of the different application types are obtained by measuring the PO at the base station for a particular application using a UDP (User Datagram Protocol) packet generator connected to a processor with the same characteristic of the processor at the base station. The UDP packet generator is able to simulate the traffic pattern of different application types by transmitting simulated information at certain data rates using the proper packet sizes defined for the particular application types. For example, a data file is typically transmitted at a certain rate and as a group of packets where each packet is 1500 bytes long. The UDP packet generator generates data packets at the various rates and the PO of the processor is measured generating curve 200 in FIG. 2. The other curves for other application types are generated in the same or similar manner using the UDP packet generator. Curve 202 represents graphics data, curve 204 represents video data and curve 206 represent e-mail messages or short message text. It should be noted that the measured PO for different AT's at different information rates using a UDP can be performed in a lab environment or at one or more various sites of an actual communication network.

In step 102 a traffic model based on the generated relationships of step 100 is provided. In particular, for the embodiment being discussed, a traffic model based on one or more of the equations generated in step 100 is provided. In the embodiment being discussed the traffic model is a linear combination of various equations using particular application types at certain information rates. In the traffic model, each equation for an AT is assigned a contribution factor that is used to multiply the equation for that application type. A linear combination is thus the multiplication of each equation in the model by a number (usually less than 1) and then adding the resulting modified equations to each other. For example, suppose there are four (4) application types where each of the four application types has an associated equation, i.e., EQ1, EQ2, EQ3 and EQ4. The total PO can be equal to 0.45 EQ1+0.15 EQ2+0.30 EQ3+0.10 EQ4 where the contribution factors for the first application type is 45%, the second application type is 15%, the third application type 30% and the fourth application type 10%. The traffic model can be obtained from various sources including standards organizations, results from studies of traffic patterns or heuristic approaches to the behavior of subscriber traffic. The method of selecting which particular traffic model to use for a communication network is arbitrary and may change over time depending on the accuracy of the traffic model in predicting traffic patterns.

For the embodiment being discussed the PO can be calculated using the following general model:
PO=C+UL contributed PO+DL contributed PO where C represents an average of all of the constants for i different application types. UL contributed PO=Σ(Fᵢ* Contributing Factorᵢ* UL Data Rate) DL contributed PO=Σ(fᵢ* Contributing Factorᵢ * DL Data Rate) (3)
where i=1, 2, . . . , n and n represents the total number of different application types; n is an integer equal to 1 or greater. The contributing factors are percentages expressing the weight or effect on the total capacity of the node from a particular AT. Various traffic models can be obtained by modifying the number of application types and the number of information rates used for the different application types. In addition to the processing of traffic information, there are other activities performed by the processor such as processing overhead information or signaling information generated by the communication network.

In step 104, the capacity of the node is calculated from the provided traffic model. In the embodiment being discussed, the various equations that make up the traffic model are used to calculate the PO for the processor at the node in the wireless communication network; that is, equation (3) is calculated for the uplink and the downlink channels yielding an aggregate PO representing the capacity of the node (i.e., base station or MSC) of a wireless communication network. The other nodes of the network can be calculated in a similar manner. The calculated PO can be adjusted to take into account processing performed on overhead information generated by equipment of the communication network. The processor at times may also process other types of information such as signaling information. The processing time for signaling information may represent a relatively small percentage (5% or less) of the PO; adjustments to the calculated PO can be made to take into account this additional processing performed by the processor. The signaling information are data/information conveyed (i.e., transmitted and/or received) between nodes of a network to allow the network to convey subscriber information in accordance with the various protocols being followed by the network.

The method of the present invention can be implemented as software running on some of the processing equipment at one or more nodes of a communication network. The calculated PO can be modified or adjusted by adjusting the provided traffic model. The provided model may adequately represent the behavior of the actual traffic pattern in which case, there would be no need to modify such a model.

1. A method for evaluating a node of a communication network, the method comprising the step of:
calculating capacity of the node based on a traffic model comprising a combination of one or more relationships between one or more application types and rates of information being conveyed through the node.

2. The method of claim 1 where the step of calculating a capacity of the node comprises
generating relationships for node capacities of different application types at different information rates; and
constructing the traffic model from a combination of the generated relationships.

3. The method of claim 1 where processor occupancy of at least one of processor at the node is calculated as the capacity of the node.

4. The method of claim 1 where the relationships are mathematical equations describing relationships between processor occupancy of at least one processor at the node and application types at certain information rates.

5. The method of claim 1 where the traffic model is a linear combination of various mathematical equations describing relationships between processor occupancy of at least one processor at the node and application types at certain information rates.

6. The method of claim 1 where the communication network is a wireless communication network.

7. The method of claim 6 where the capacity is calculated by calculating a processor occupancy of at least one processor at the node from a traffic model comprising a linear combination of various mathematical equations describing particular relationships between an information rate of a particular application type and a resulting processor occupancy.

8. The method of claim 7 where the at least one processor processes subscriber information.

9. The method of claim 6 where the capacity is calculated by calculating processor occupancy for an uplink and a downlink of at least one processor at the node.
